(19) United States
(12) Patent Application Publication
(10) Pub. No.: US 2020/0271508 A1
(43) Pub. Date: Aug. 27, 2020

(54) WEIGHING APPARATUS AND METHOD FOR WEIGHING FOOD PRODUCT

(71) Applicant: ISHIDA EUROPE LIMITED, Birmingham, West Midlands (GB)

(72) Inventor: Nick CLARK, Birmingham, West Midlands (GB)

(21) Appl. No.: 16/648,218

(22) PCT Filed: Sep. 19, 2018
(86) PCT No.: PCT/GB2018/052674

§ 371 Date: Mar. 17, 2020

(30) Foreign Application Priority Data
Sep. 19, 2017 (GB) 1715088.9

(51) Int. Cl. G01G 13/02; B65G 33/18; B65G 65/48; G01G 19/393; G01G 13/24

(52) U.S. Cl. CPC G01G 13/026; B65G 33/18; B65G 65/4881; B65G 2812/0527; G01G 13/248; B65G 2201/0202; B65G 2203/0258; G01G 19/393

(57) ABSTRACT

A weighing apparatus for weighing batches of food product is provided. The weighing apparatus comprises a product supply unit arranged to supply food product to be weighed, a weighing unit arranged to receive and weigh a batch of food product, and a product delivery unit arranged to receive the food product from the product supply unit and to deliver a batch of food product to the weighing unit. The product delivery unit comprises a trough extending between a product supply position, at which food product is received from the product supply unit, and a product delivery position, at which the food product is delivered for receipt in the weighing unit, and a transport screw arranged in the trough and configured to rotate in the trough for conveying food product from the product supply position to the product delivery position. The transport screw comprises at least two helical members. A primary helical member extends along a length of the trough substantially from the product supply position to the product delivery position. A secondary helical member extends along a length of the trough substantially from the product supply position to a termination position of the secondary helical member, the termination position of the secondary helical member being between the product supply position and the product delivery position.

### FIELD OF THE INVENTION

The present invention relates to apparatuses and methods for weighing batches of food product. In particular, the present invention relates to apparatuses and methods for weighing batches of difficult-to-handle food product comprising a large number of discrete pieces. Such food product includes sticky food product such as raw meat, poultry and fish, in particular where these are coated in sauces or marinades.

### BACKGROUND OF THE INVENTION

Weighing apparatuses that receive food product in bulk and then deliver batches of this food product to a weigher in a controlled manner are widely used in the art. A particular apparatus for delivering and weighing a batch of food product comprises a transport screw that has a helical member that rotates about its centre axis to drive food product along a trough from a first end, at which the food product is received, to a second end, at which the food product is delivered to a weigher. An example of such a system may be found in EP 2175250 A1.

Movement of food product along a trough by a helical member helps to break up clumps of sticky food and allow for the food product to be delivered in a controlled manner to the weigher for weighing. However, it has been found that sticky food product such as raw meat, poultry and fish will often enter into the centre of the transport screw, which prevents it from being adequately broken up. This can result in large clumps of food product being delivered to the weigher, often resulting in overweight batches of food product, or can result in clogging of the transport screw. This problem was addressed in WO 2006/092148 A1 by providing a solid core along the centre of the transport screw to prevent food product entering the centre of the helical member. However, problems with this solution include that product can be damaged if it is caught between the core and the helical member and that the provision of a large core significantly increases the cleaning requirements when the apparatus is cleaned between changes of the type of food product being weighed.

It is desirable to provide a way of handling food product that avoids the formation of clumps of food product along the centre of a transport screw while minimising damage to the product and cleaning requirements.

### SUMMARY OF THE INVENTION

In accordance with a first aspect of the present invention, there is provided a weighing apparatus for weighing batches of food product, the weighing apparatus comprising: a product supply unit arranged to supply food product to be weighed; a weighing unit arranged to receive and weigh a batch of food product; and a product delivery unit arranged to receive the food product from the product supply unit and to deliver a batch of food product to the weighing unit, the product delivery unit comprising: a trough extending between a product supply position, at which food product is received from the product supply unit, and a product delivery position, at which the food product is delivered for receipt in the weighing unit; a transport screw arranged in the trough and configured to rotate in the trough for conveying food product from the product supply position to the product delivery position; wherein the transport screw comprises at least two helical members (preferably helical rods), wherein a primary helical member extends along a length of the trough (substantially) from the product supply position to the product delivery position and wherein a secondary helical member extends along a length of the trough (substantially) from the product supply position to a termination position of the secondary helical member, the termination position of the secondary helical member being between the product supply position and the product delivery position.

In addition to a primary helical member the present invention provides a secondary helical member that extends only part way along the trough from the product supply position towards the product delivery position, i.e. the secondary helical member is shorter than the primary helical member. This secondary helical member effectively increases the surface area of the transport screw in the upstream end of the trough. It has been found that providing the secondary helical member only along an upstream portion of the trough is sufficient to breakdown any clumps of product as they are initially conveyed along the trough away from the product supply unit. Once any initial clumps of food product are sufficiently broken down, the tendency of the food product to form clumps in the centre of the transport screw is significantly reduced. Accordingly, the secondary transport screw terminates part way along the trough, reducing the surface area of the screw that must be cleaned between changes of food product.

The apparatus according to the invention comprises a product supply unit which typically receives or stores product in bulk and supplies this in substantially unmeasured quantities to a product supply position of the product delivery unit. It will be appreciated that the product supply unit may comprise guiding means, such as a chute, for guiding product away from the body of the supply unit before arriving at the product supply position. Once received at the product supply position, the food product is conveyed along the trough by the transport screw, which breaks up any initial clumps of food product. The product is delivered by the transport screw to a product delivery position, typically at the distal end of the transport screw (although the primary helical member could extend beyond the product delivery position). Preferably this product delivery position corresponds to an upper opening of the weighing unit, but it is foreseen that additional guiding means could be used to guide the product away from the trough before being received in the weighing unit. Once received in the weighing unit, the batch of food product is weighed before being discharged for downstream processing.

For consistent handling of food product, preferably the primary helical member and/or the secondary helical member has a constant radius of curvature. In the present context, the radius of curvature of a helical member means the distance between the helical member and its central axis. While preferable, in other embodiments, the radius of curvature of either or both the primary helical member and the secondary helical member could increase or decrease gradually towards to the product delivery position.

Particularly preferably the primary helical member and the secondary helical member have substantially the same radius of curvature between the product supply position and the termination position of the secondary helical member. By this it is meant that the primary helical member has the same radius of curvature as the secondary helical member. This improves the integration of the two helical members. In alternative embodiments, the primary helical member and the secondary helical member may have different radii of curvature. For example, the secondary helical member may be slightly smaller in diameter than the primary helical member and, for example, may be located within the primary helical member.

In some embodiments, the primary helical member and/or the secondary helical member has a constant pitch, i.e. the length of one complete helix turn, measured parallel to the central axis of the helix, which may be advantageous for handling of product. However, embodiments are also foreseen in which the primary helical member and/or the secondary helical member has a pitch that increases towards the product delivery position. In either case, preferably the primary helical member and the secondary helical member have substantially the same pitch between the product supply position and the termination position of the secondary helical member. Matching the pitches of the helical members ensures consistent handling of food product and facilitates integration of the helical members.

In many cases, the secondary helical member is arranged substantially coaxial to the primary helical member. Coaxial in this context means that the helical members share the same central or longitudinal axis. While preferable, an offset of the two central axes could be used, for example, to cause agitation of the food product in the trough. Further, preferably, the primary and secondary helical members are each open along their central axis.

In a preferred implementation of the present invention, the secondary helical member substantially corresponds to a phase-shifted version of a section of the primary helical member between the product supply position and the termination position of the secondary helical member. By this it is meant that the secondary helical member substantially matches the shape of the primary helical member, but is displaced along the centre axis by a distance equal to a fraction of the pitch of the primary helical member.

Preferably, the termination position of the secondary helical member is at a position between 10% and 90% of the distance between the product supply position and the product delivery position, preferably between 20% and 80%, more preferably between 30% and 70%, further preferably between 40% and 60% of the distance between the product supply position and the product delivery position. A secondary helical member with approximately half the length of the primary helical member has been found to strike a good balance between improved handling of product and reduction in surface area of the transport screw. However, the exact length may be configured, as set out above, depending on the characteristics of the product being weighed.

The present invention is not limited to a single primary helical member and indeed in some embodiments the transport screw comprises first and second primary helical members, wherein each primary helical member extends along a length of the trough substantially from the product supply position to the product delivery position. It should be noted here that any teaching above or below relating to a single primary helical member applies equally to primary helical members constituting a plurality of primary helical members. Providing a plurality of primary helical members can reduce the stresses on the end of the helical member during rotating of the screw, i.e. as the mass of each helical member may be halved while achieving essentially the same surface area. Alternatively, additional primary screws may act to provide a smaller effective pitch of the screw, for handling particularly difficult food product. Preferably, the first and second primary helical members have substantially the same radius of curvature, pitch and/or length and further preferably, the first and second primary helical members are substantially coaxial. In some embodiments, the second primary helical member is a phase-shifted version of the first primary helical member, preferably being approximately 180° out of phase, i.e. the two helical members having the form of a double helix. In some cases, the first and second primary helical members may be between 130° and 230°, preferably between 150° and 210° out of phase.

Additionally, the present invention is not limited to a single secondary helical member and in some embodiments the transport screw comprises first and second secondary helical members, wherein the first secondary helical member extends along a length of the trough substantially from the product supply position to a termination position of the first secondary helical member and wherein the second secondary helical member extends along a length of the trough substantially from the product supply position to a termination position of the second secondary helical member, the termination positions of the first and second secondary helical members being between the product supply position and the product delivery position. Again, it should be noted here that any teaching above or below relating to a single secondary helical member applies equally to secondary helical members constituting a plurality of secondary helical members. As with the primary helical members, preferably the first and second secondary helical members have substantially the same radius of curvature and/or pitch and also preferably the first and second secondary helical members are substantially coaxial. In some embodiments, the second secondary helical member is a phase-shifted version of the first secondary helical member, preferably being approximately 180° out of phase. In some cases, the first and second secondary helical members may be between 130° and 230°, preferably between 150° and 210° out of phase.

In embodiments comprising two secondary helical members, these may be of the same or different lengths. For example, the termination positions of the first and second secondary helical members may be substantially the same distance between the product supply position and the product delivery position. Alternatively, the termination position of the first secondary helical member may be between the product supply position and the termination position of the second secondary helical member. For example, terminating the first secondary helical member before or after the second secondary helical member may provide a more gradual transition in surface area of the transport screw between the product supply position and the product delivery position.

While the present invention has been described as providing an alternative to a solid core within the transport screw, these two are not incompatible and may indeed be used in combination. For example, in some embodiments, the transport screw further comprises a core positioned inside the primary and secondary helical members. This core may extend the full length of the primary helical member, or may be shorter than the primary helical member and/or shorter than the secondary helical member. For example, a core that extends part way between the product supply position and the termination position of the secondary helical member may reinforce the transport screws ability to prevent product entering the centre of the screw while the product is in its most clumped together state.

In many embodiments, rotation of the transport screw comprises rotation of the primary and secondary helical members about their longitudinal axes, although in alternative embodiments, there may be an intentional misalignment between the rotation axis and the centre axis of one or more of the helical members. Further, preferably the primary and secondary helical members are fixedly mounted with respect to one another, although it also foreseen that they could be independently driven to rotate at the same or a similar speed. In many embodiments, the primary and secondary helical members are fixedly mounted to a (common) rotatable support plate.

In many embodiments, an inner surface of the trough has a radius of curvature equal to or greater than the radius of curvature of the larger of the primary and/or secondary helical members. That is to say that a lower half of the trough has a semi-circular cross-section with radius equal to or greater than the radius of curvature of the larger of the primary and/or secondary helical members. Where the radius of curvature is equal to the radius of curvature of the primary or secondary helical members, the helical member may contact the inner surface of trough. This may be advantageous when product coated in liquid marinades is being conveyed. Alternatively, the where the radius of curvature is greater than the radius of curvature of the primary or secondary helical members, there may be a gap between the helical members and the trough, which may minimise damage of product.

While the transport screw could be manually operated, preferably the apparatus further comprises a motor arranged to drive the rotation of the transport screw. In many such embodiments, the apparatus will further comprise a control unit configured to control the rotation of the transport screw by the motor. The control unit may be configured to control the rotation of the transport screw by the motor on the basis of an output of the weighing unit. For example, on the basis of the weight of a previous batch, the screw may be driven faster or slower or for less or more time per batch to adjust the approximate weight of food product delivered to the weighing unit.

In accordance with a second aspect of the present invention there is provided a method of weighing batches of food product comprising: supplying food product for receipt at a product supply position using a product supply unit; receiving the food product at the product supply position using a product delivery unit; delivering a batch of food product to a product delivery position using the product delivery unit; receiving the batch of food product delivered to the product delivery position in a weighing unit; and weighing the batch of food product using the weighing unit; wherein the product delivery unit comprises: a trough extending between the product supply position and the product delivery position; a transport screw arranged in the trough and configured to rotate in the trough for conveying food product from the product supply position to the product delivery position, the transport screw comprising at least two helical members, wherein a primary helical member extends along a length of the trough substantially from the product supply position to the product delivery position and wherein a secondary helical member extends along a length of the trough substantially from the product supply position to a termination position of the secondary helical member, the termination position of the secondary helical member being between the product supply position and the product delivery position.

This method is suitable for operation using an apparatus according to the first aspect of the invention and shares the same advantages discussed above. It will be appreciated that the various advantageous features described above with respect to the first aspect of the invention apply equally to the method according to this second aspect of the invention.

### BRIEF DESCRIPTION OF THE DRAWINGS

Embodiments of the invention will now be described with reference to the following Figures, in which:

FIG. 1 is a schematic top view of a weighing apparatus according to a first embodiment of the invention;

FIG. 2 is a schematic top view of the weighing apparatus according to the first embodiment of the invention with the supply unit omitted;

FIG. 3 is a schematic cross-section of the weighing apparatus according to the first embodiment of the invention;

FIG. 4 is a top view of a product delivery unit of the weighing apparatus according to the first embodiment of the invention;

FIG. 5 is an end view of the product delivery unit of the weighing apparatus according to the first embodiment of the invention;

FIG. 6 is a top view of a product delivery unit of a weighing apparatus according to a second embodiment of the invention; and

FIG. 7 is a top view of a product delivery unit of a weighing apparatus according to a third embodiment of the invention.

### DETAILED DESCRIPTION OF THE INVENTION

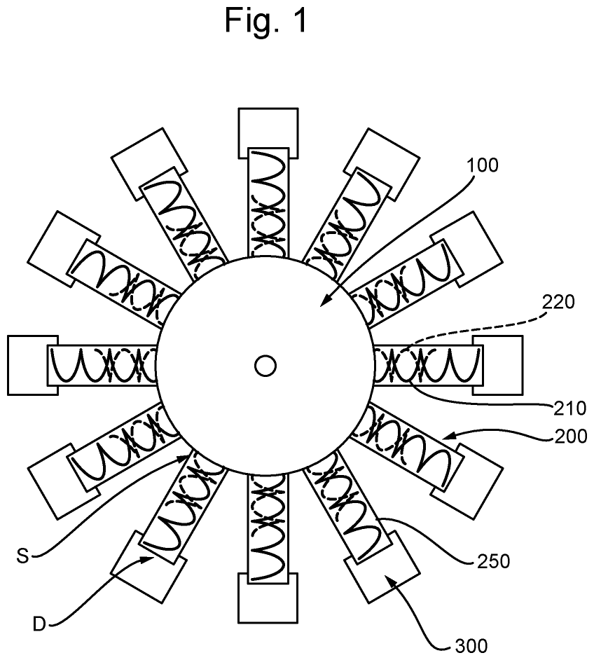

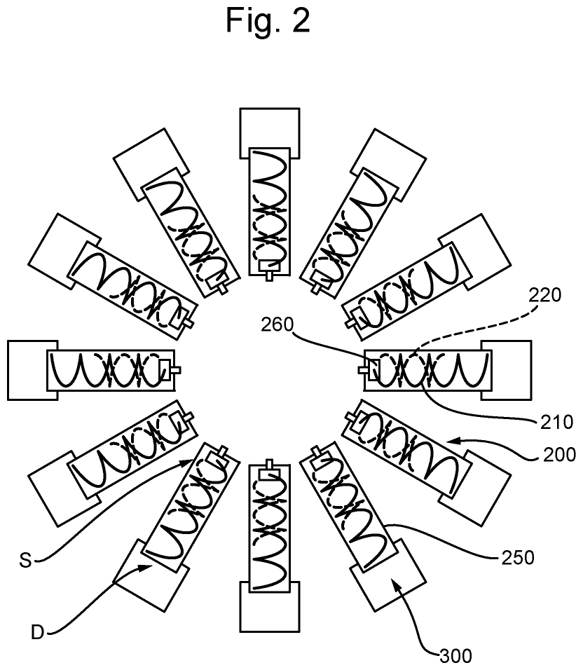

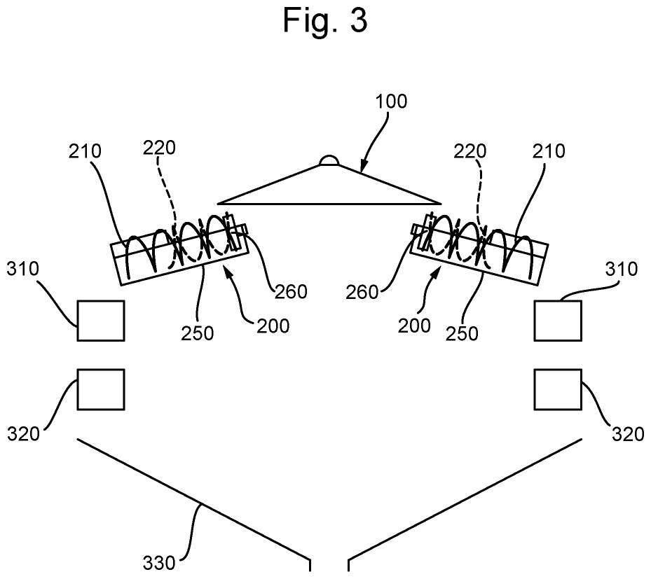

FIG. 1 is a top view depicting the overall configuration of a weighing apparatus (this embodiment showing a type of weigher often referred to as a combination weigher) according to a first embodiment of the present invention. FIG. 2 shows the same weighing apparatus, but with the product supply unit 100 omitted to schematically depict the product delivery units 200 the weighing units 300. FIG. 3 is a side cross-sectional view of the overall configuration of the weighing apparatus of FIG. 1. The weighing apparatus includes a product supply unit 100, a plurality of product delivery units 200 arranged around and extending radially from the product supply unit 100, and a corresponding plurality of weighing units 300 at the distal end of each product delivery unit. The present embodiment shows twelve product delivery units 200; however, any number of product delivery units 200 may be used, including only one product delivery unit.

In the present embodiment, the product supply unit 100 comprises a distribution table, which has a generally cone shaped upper surface whose periphery overlaps the plurality of product delivery units. In use, food product is received on the distribution table and is directed towards the periphery by the inclined surfaces of the table. Gaps in a sidewall of the distribution table (not shown) ensure that product that falls off of the distribution table is received in a product delivery unit 200.

Each product delivery unit 200 comprises a transport screw made up of helical members 210 and 220, which will be described in more detail below. The transport screw sits in an open inclined trough 250 and rotates in the trough to convey food product radially away from the product supply unit 100. In more detail, food product that is supplied by the product supply unit is received in the trough 250 at a product supply position S, which is substantially directly below the periphery of the distribution table. The trough and transport screw extend inwardly beyond the periphery of the distribution table such that product at the product supply position S is received in the trough 250 and is immediately under the influence of the rotating transport screw. Rotation of the transport screw in the trough moves the food product in a controlled manner from the product supply position S towards the product delivery position D, at which it is urged off the end of the trough 250 and falls into the weighing unit 300. The trough and screw are arranged on an incline such that the product supply position S is higher than the product delivery position D to facilitate the delivery of the product along the trough and into the weighing unit 300.

As shown in FIG. 3, each weighing unit comprises a pool hopper 310 vertically above a corresponding weighing hopper 320. The product urged off the end of the trough 250 at the product delivery position D by the transport screw is received first in the pool hopper 310 and is temporarily retained inside the pool hoppers. The food product is then discharged from the pool hopper 310 and received in the weighing hopper 320. The food product is temporarily stored inside the weighing hopper 320, where it is weighed by load cells or other weighing means (not shown). In a combination weigher, the weights in each weigher are sent to a controller (not shown), which determines which combination of the twelve weighers contains a weight of food product that is close enough to the target weight. Those weighers are then operated to dispense the food product. The corresponding pool hoppers 310 are then operated to dispense food product into the now empty weighing hoppers 320 and the corresponding transport screws rotated to fill the now empty pool hoppers 310, at which point a new combination is determined and the cycle repeated.

Food product dispensed from the selected weighing hoppers 320 falls under gravity into a common collecting chute 300, where the multiple batches of food product are combined into a single batch with an appropriate weight and directed to a discharge position for downstream processing.

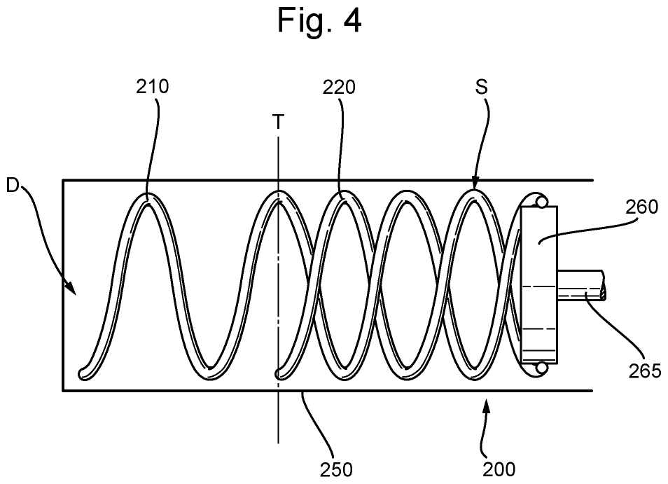

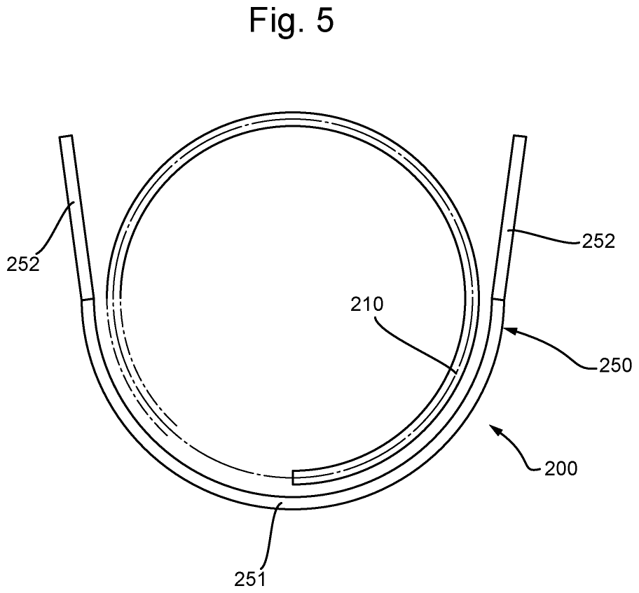

The transport screw will now be described in more detail with reference to FIGS. 4 and 5, which show the transport screw sat in the trough 250.

FIG. 4 shows that each transport screw comprises a circular support plate 260 that is rotatable about its centre by a drive shaft 265 extending from a rear surface of the circular plate and coupled to a motor (not shown). First and second helical members 210, 220 are coupled to the periphery of the circular plate 260 and extend away from the circular plate in a direction opposite to the drive shaft. The centre axis of each helical member 210, 220 is coincident with the centre of the circular plate 260 and coincident with the axis of the drive shaft 265 such that rotation of the circular plate about its centre causes the helical members to rotate about their centre axes.

The first helical member is a primary helical member 210 and extends from the circular plate 260, towards the end of the trough 250. In use, the primary helical member 210 extends through the product supply position S, at which food product is received from the product supply unit 100, substantially to the product delivery position D, which in this embodiment substantially corresponds to the end of the trough 250. The primary helical member ensures that food product is conveyed from the product supply position S to the product delivery position D.

The second helical member is a secondary helical member 220 and extends from the circular plate 260, towards the end of the trough 250. The secondary helical member is shorter than the primary helical member and terminates at a termination position T, which is approximately halfway between the product supply position and the product delivery position D. The secondary helical member 220 helps convey food product away from the product supply position S and additionally helps prevent food product from building up in the centre of the transport screw in the upstream portion of the trough 250.

Each helical member is a helical rod member and may be made of, for example, stainless steel or a suitable plastic material. In this embodiment, the primary and secondary helical members 210, 220 have the same radius of curvature and pitch of the coils that make up the helix shape. Additionally, the primary and secondary helical members 210, 220 are mounted coaxially and rotate about their common axis. Indeed, the secondary helical member corresponds 220 to a phase shifted version of the portion of the primary helical member 210 between the circular plate 260 and the termination position T. In alternative embodiments, the secondary helical member may have a smaller radius of curvature and/or may have a smaller pitch than the primary helical member to control the product handling characteristics of the transport screw.

As shown in FIG. 5, the transport screw sits in an open trough 250. The open trough comprises a lower semi-cylindrical portion 251 and two sidewalls 252. The semi-cylindrical portion 251 has an inner surface whose radius of curvature is only slightly greater than the radius of curvature of the primary and secondary helical members 210, 220 such that the screw fits within the semi-cylindrical portion of the trough and can effectively convey food product along the trough. The sidewalls 252 extend along the length of the transport screw and project upwards from the long edges of the semi-cylindrical portion 251 to ensure that product is not ejected from the trough by rotation of the transport screw.

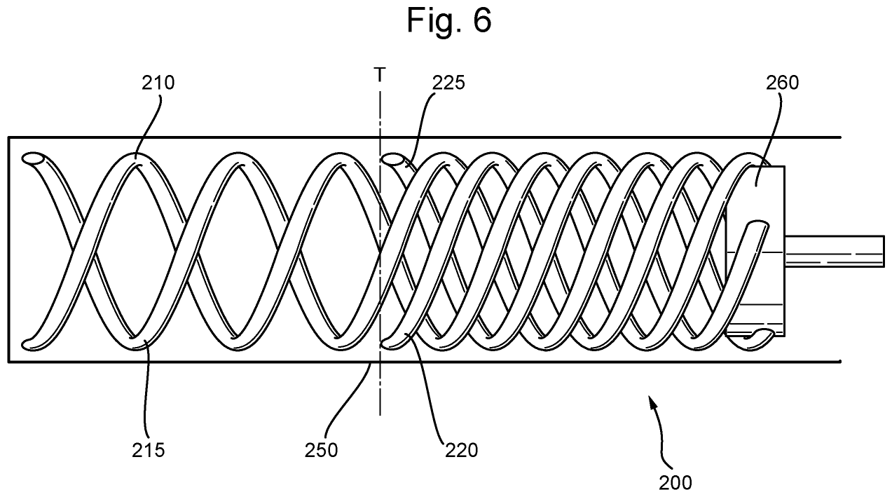

FIG. 6 shows an alternative transport screw, suitable for use in a weighing apparatus according to a second embodiment of the invention.

This transport screw comprises a first primary helical member 210 and a second primary helical member 215. The second primary helical member is substantially identical to the first primary helical member described with respect to FIG. 4, but is phase-shifted by approximately 180° relative to the first primary helical member such that the first and second primary helical members 210, 215 together have a double helix form. As above, both primary helical member 210, 215 extend, in use, through the product supply position S, at which food product is received from the product supply unit 100, substantially to the product delivery position D, which again corresponds to the end of the trough 250 and ensure that food product is conveyed from the product supply position S to the product delivery position D.

Similarly, this transport screw also comprises a first secondary helical member 220 and a second secondary helical member 225. The second secondary helical member is substantially identical to the first secondary helical member described with respect to FIG. 4, but is phase-shifted by approximately 180° relative to the first secondary helical member such that the first and second secondary helical members 220, 225 together have a double helix form. Both the first secondary helical member 220 and the second secondary helical member 225 are the same length, and extend from the circular plate along the trough 250 to the same termination position T. It will be appreciated here that the same termination position T means same length along the trough 250, as the precise end points of the helical members will be offset from one another owing to the difference in phase of the helical members.

The two primary helical members 210, 215 are out of phase with the secondary helical members 220, 225 by approximately 90° such that each individual helical member is phase-shifted by approximately 90° compared to the adjacent helical member in the region of the trough upstream of the termination position T.

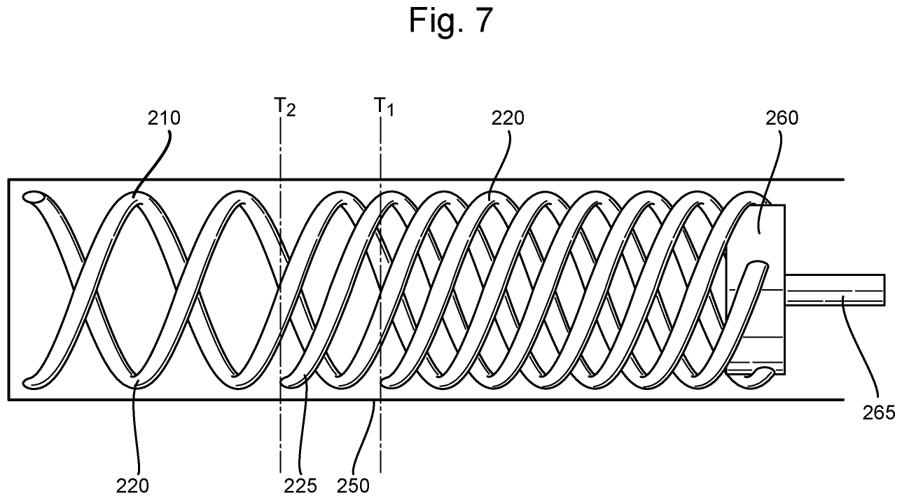

FIG. 7 shows another alternative transport screw, suitable for use in a weighing apparatus according to a third embodiment of the invention.

This transport screw differs from that described above with respect to FIG. 6 only in that the first and second secondary helical members are different lengths. More specifically, the first secondary helical member 220 extends from the circular plate 260 along the trough 250, terminating at a termination position which is a first distance along the length of the trough. The second secondary helical member 225 extends from the circular plate 260 along the trough 250, terminating at a position T₂, which is a second distance along the length of the trough, greater than the distance of T₁. This provides a more gradual change in surface area of the screw between the supply position, at which all four helical members are present, to the delivery position, at which only the two primary helical members 210, 215 are present.

While the embodiments of FIGS. 6 and 7 describe two secondary helical members in combination with two primary helical members, the number of primary and secondary helical members can be varied independently of one another.

1. A weighing apparatus for weighing batches of food product, the weighing apparatus comprising:
a product supply unit arranged to supply food product to be weighed;
a weighing unit arranged to receive and weigh a batch of food product; and
a product delivery unit arranged to receive the food product from the product supply unit and to deliver a batch of food product to the weighing unit, the product delivery unit comprising:
a trough extending between a product supply position, at which food product is received from the product supply unit, and a product delivery position, at which the food product is delivered for receipt in the weighing unit; and
a transport screw arranged in the trough and configured to rotate in the trough for conveying food product from the product supply position to the product delivery position;
wherein the transport screw comprises at least two helical members, wherein a primary helical member extends along a length of the trough substantially from the product supply position to the product delivery position and wherein a secondary helical member extends along a length of the trough substantially from the product supply position to a termination position of the secondary helical member, the termination position of the secondary helical member being partway between the product supply position and the product delivery position.

2. A weighing apparatus according to claim 1, wherein the primary helical member and/or the secondary helical member has a constant radius of curvature.

3. A weighing apparatus according to claim 1, wherein the primary helical member and the secondary helical member have substantially the same radius of curvature between the product supply position and the termination position of the secondary helical member.

4. A weighing apparatus according to claim 1, wherein the primary helical member and/or the secondary helical member has a constant pitch, or a pitch that increases towards the product delivery position.

5. (canceled)

6. A weighing apparatus according to claim 1, wherein the primary helical member and the secondary helical member have substantially the same pitch between the product supply position and the termination position of the secondary helical member.

7. A weighing apparatus according to claim 1, wherein the secondary helical member is arranged substantially coaxial to the primary helical member.

8. (canceled)

9. A weighing apparatus according to claim 1, wherein the termination position of the secondary helical member is at a position at a distance from the product supply position to the product delivery position selected from the group consisting of between 10% and 90% between 20% and 80%, between 30% and 70%, between 40% and 60%.

10. A weighing apparatus according to claim 1, wherein the transport screw comprises first and second primary helical members, wherein each primary helical member extends along a length of the trough substantially from the product supply position to the product delivery position.

11. A weighing apparatus according to claim 10, wherein the first and second primary helical members have substantially the same radius of curvature, pitch and/or length.

12. A weighing apparatus according to claim 10, wherein the first and second primary helical members are substantially coaxial.

13. (canceled)

14. A weighing apparatus according to claim 1, wherein the transport screw comprises first and second secondary helical members, wherein the first secondary helical member extends along a length of the trough substantially from the product supply position to a termination position of the first secondary helical member and wherein the second secondary helical member extends along a length of the trough substantially from the product supply position to a termination position of the second secondary helical member, the termination positions of the first and second secondary helical members being between the product supply position and the product delivery position.

15. A weighing apparatus according to claim 14, wherein the first and second secondary helical members have substantially the same radius of curvature and/or pitch.

16. A weighing apparatus according to claim 14, wherein the first and second secondary helical members are substantially coaxial.

17. (canceled)

18. (canceled)

19. A weighing apparatus according to claim 1, wherein the transport screw further comprises a core positioned inside the primary and secondary helical members.

20. A weighing apparatus according to claim 1, wherein rotation of the transport screw comprises rotation of the primary and secondary helical members about their longitudinal axes.

21. (canceled)

22. (canceled)

23. A weighing apparatus according to claim 1 the primary and secondary helical members are each open along their central axis.

24. (canceled)

25. (canceled)

26. (canceled)

27. (canceled)

28. A weighing apparatus according to claim 1 comprising a plurality of weighing units, each arranged to receive and weigh a batch of food product, and a corresponding plurality of product delivery units, each product delivery unit being arranged to receive food product from the product supply unit and to deliver a batch of food product to the corresponding weighing unit.

29. A weighing apparatus according to 28, wherein the plurality of product delivery units are arranged around a periphery of the product supply unit, and wherein the product supply unit is configured to distribute product radially for receipt at the product supply position of each of the product delivery units.

30. A weighing apparatus according to claim 1, wherein the or each product delivery unit is arranged in use such that the trough is in an inclined orientation, the product supply position being higher than the product delivery position.

31. A method of weighing batches of food product comprising:
supplying food product for receipt at a product supply position using a product supply unit;
receiving the food product at the product supply position using a product delivery unit;
delivering a batch of food product to a product delivery position using the product delivery unit;
receiving the batch of food product delivered to the product delivery position in a weighing unit; and
weighing the batch of food product using the weighing unit;
wherein the product delivery unit comprises:
a trough extending between the product supply position and the product delivery position;
a transport screw arranged in the trough and configured to rotate in the trough for conveying food product from the product supply position to the product delivery position, the transport screw comprising at least two helical members, wherein a primary helical member extends along a length of the trough substantially from the product supply position to the product delivery position and wherein a secondary helical member extends along a length of the trough substantially from the product supply position to a termination position of the secondary helical member, the termination position of the secondary helical member being between the product supply position and the product delivery position.

32. (canceled)
